(19) United States
(12) Patent Application Publication
(10) Pub. No.: US 2004/0016466 A1
(43) Pub. Date: Jan. 29, 2004

(54) In-line flow through diaphragm tank

(76) Inventors: Robert Lombari, North Smithfield, RI (US); Wei-Chiao Lo, Taichung (TW)

Correspondence Address: Choate, Hall & Stewart, Exchange Place, 53 State Street, Boston, MA, 02109, US

(21) Appl. No.: 10/281,708

(22) Filed: Oct. 28, 2002

Related U.S. Application Data
(60) Provisional application No. 60/398,765, filed on Jul. 25, 2002.

(51) Int. Cl. F16L 55/04

(52) U.S. Cl. 138/30

(57) ABSTRACT

An in-line expansion tank. As fluid traverses a pipe within the tank, it may pass into and displace a diaphragm disposed outside of the pipe if the fluid pressure is greater than a tank pressure pushing the diaphragm against the pipe. When the fluid pressure decreases, the fluid passes from the diaphragm back into the pipe.

This application claims priority from U.S. Provisional Application No. 60/398,765, filed Jul. 25, 2002, which is incorporated herein by reference.

### FIELD OF THE INVENTION

The invention pertains to a diaphragm tank, and more specifically, to a flow through diaphragm tank having robust construction.

### BACKGROUND OF THE INVENTION

Water expands when heated. In a closed system, this expansion may cause dangerous increases in water pressure. While water heaters have relief valves to vent excess pressure and prevent damage to the water heater and surrounding piping, it is undesirable to have hot water venting out of a tank in a residential setting. As a result, expansion tanks are used to absorb the excess pressure and release water back into the water heater when the pressure decreases.

### SUMMARY OF THE INVENTION

In one aspect, the invention is an in-line expansion tank including a case having first and second passage fittings providing fluidic communication between an exterior and an interior of the case, first and second collars sealingly connected to the first and second passage fittings, a resilient diaphragm having first and second ends sealingly connected to an exterior of the first and second collars, respectively, and a tube retained between the first and second collars and having two ends. One or both ends of the tube have a notch providing fluidic communication between an interior of the tube and an interior of the diaphragm. The case may be metallic and may include a shell having first and second ends and first and second domes welded to the first and second ends of the shell, respectively. The passage fittings may each be disposed in a wall of a dome. The tank may further include a valve providing controllable fluidic communication between an exterior of the tank and a space between the case and the diaphragm. The valve may be disposed in a wall of one of the domes or of the shell.

A cross-sectional area of the first and second ends of the diaphragm may be smaller than a cross-sectional area of a middle portion of the diaphragm. One or both ends of the tube may have a plurality of notches. A middle portion of the diaphragm may be configured to contact the tube at normal operating pressures.

In another aspect, the invention is an in-line expansion tank including a case having an inlet and an outlet, a flow-through assembly having an interior and an exterior and first and second ends sealingly connected to the inlet and outlet, respectively, and a resilient diaphragm having a middle portion and first and second ends sealingly connected to the flow-through assembly. The cross-sectional area of the first and second ends of the diaphragm are smaller than a cross-sectional area of the middle portion, and a space between the exterior of the flow-through assembly and the interior of the diaphragm is in fluidic communication with the interior of the flow-through assembly. The flow-through assembly may include first and second collars sealingly connected to the inlet and outlet, respectively, and a tube retained between the first and second collars and having two ends. One or both ends of the tube may have a notch providing fluidic communication between an interior of the tube and an interior of the diaphragm.

In another aspect, the invention is an in-line expansion tank including a metallic case, a flow-through assembly having an interior and an exterior, and a resilient diaphragm having inlet and outlet ends sealingly connected to the flow-through assembly. A space between the exterior of the flow-through assembly and an interior of the diaphragm are in fluidic communication. The metallic case includes a shell having first and second ends, first and second domes welded to the first and second ends of the shell, respectively, and first and second fittings attached to the first and second domes, respectively, and adapted and constructed for connection to a plumbing system and providing fluidic communication between an interior and an exterior of the case. First and second ends of the flow-through assembly are sealingly connected to the first and second fittings of the metallic case, respectively.

In another aspect, the invention is a pre-assembled water chamber assembly for an expansion tank including a tube having first and second ends, first and second collars disposed at the first and second ends of the tube, respectively, and a resilient diaphragm having first and second ends. The diaphragm is disposed about the tube and the first and second ends of the diaphragm are sealingly fitted around the first and second collars, respectively.

### BRIEF DESCRIPTION OF THE DRAWING

The invention is described with reference to the several figures of the drawing, in which,

FIG. 1 is a schematic diagram of an in-line flow through diaphragm tank according to an embodiment of the invention;

FIG. 1A is an exploded view of a valve body illustrated in FIG. 1;

FIG. 2 is an exploded view of the diaphragm tank illustrated in FIG. 1; and

FIG. 3 is a schematic of a portion of a plumbing system including a diaphragm tank according to an embodiment of the invention.

### DETAILED DESCRIPTION OF CERTAIN PREFERRED EMBODIMENTS

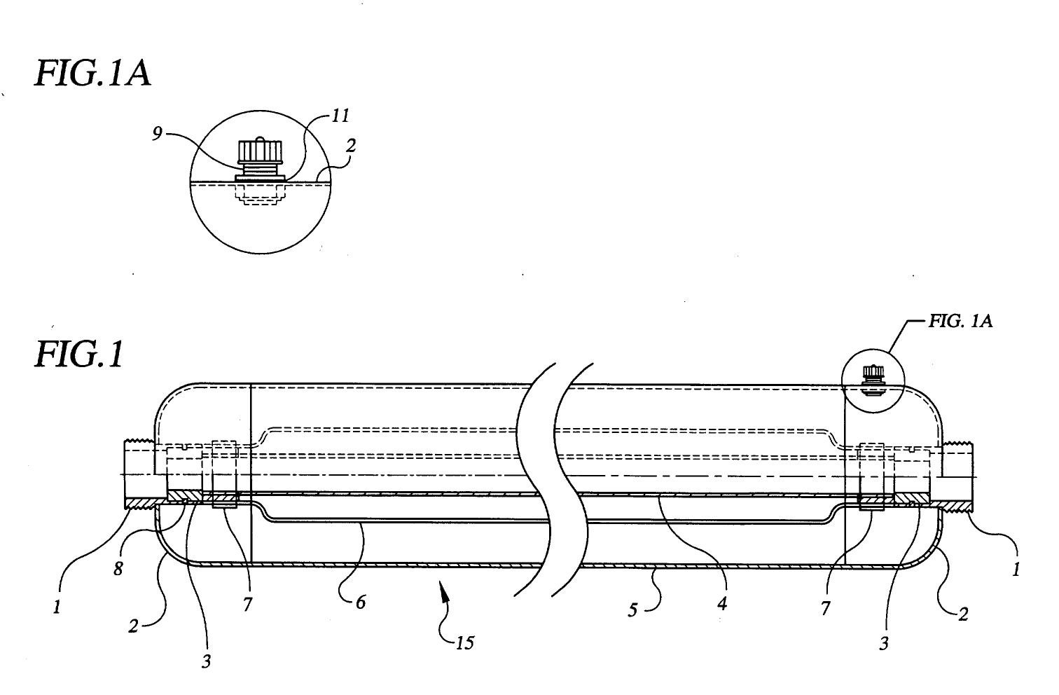

FIG. 1 illustrates a flow-through expansion tank 10 according to an embodiment of the invention. The tank 10 includes an external case, for example, pressure assembly 15, and an interior assembly via which water or other liquids flow through the tank 10, for example, water chamber assembly 12. The pressure assembly 15 includes a shell 5 that is capped at each end by domes 2. One skilled in the art will recognize that domes 2 may take on any shape so long as they may be attached to shell 5. For example, domes 2 may be cup-shaped, as shown, or flat caps with squared or rounded corners, or some other shape. It is preferable that the domes not flex as the pressure within pressure assembly 15 changes. One of the domes 2 may be fitted with a valve body 8 through which the interior of pressure assembly 15 may be charged with air or vented. Alternatively, valve body 8 may be disposed in shell 5. Under normal pressures, water flows through the tank 10 by entering at one fitting 1, flowing through water chamber assembly 12, and exiting the tank 10 at the second fitting 1.

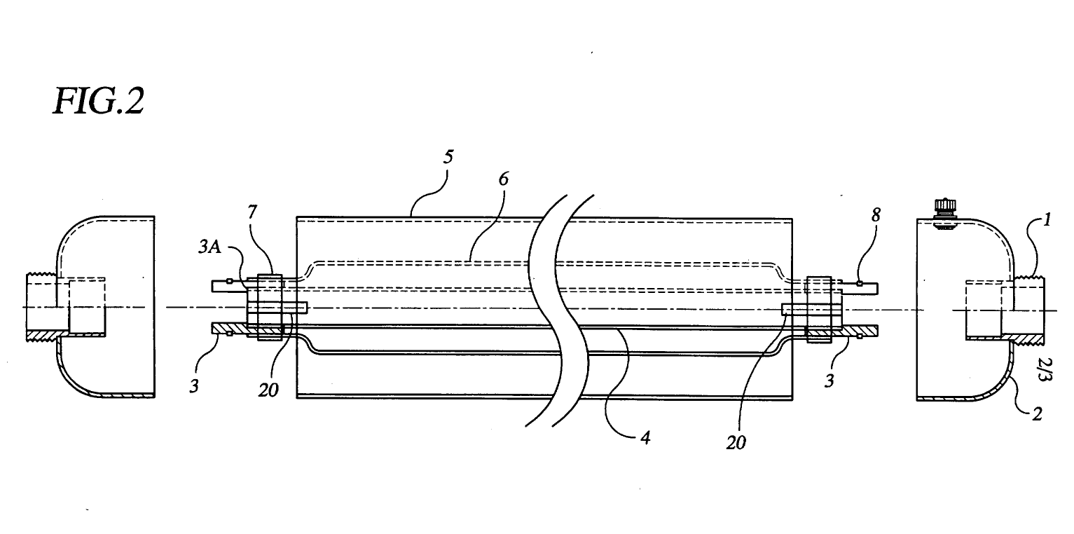

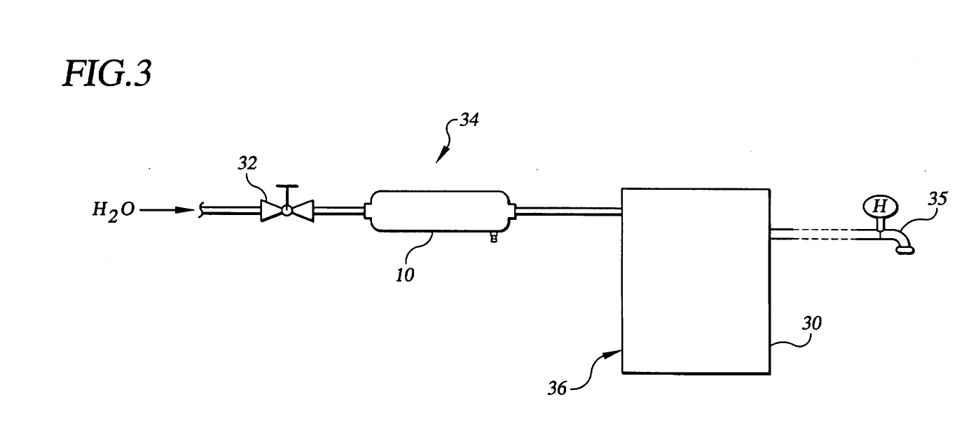

An exploded view of the tank 10, isolating water chamber assembly 12, is shown in FIG. 2. The ends of tube 4 are inserted into collars 3. In a preferred embodiment, each collar 3 has a shoulder 3A to prevent lateral motion of tube 4 within the collar 3. Diaphragm 6 fits around the outside of collar 3 and is retained in place by clamps 7. In a preferred embodiment, the ends of diaphragm 6 are tapered to reduce stress on the ends of the diaphragm 6 as it expands away from tube 4 (see below). Clamp 7 also prevents water leakage from water chamber assembly 12 to the space between the diaphragm 6 and pressure assembly 15. To assemble the tank 10, the water chamber assembly 12 is passed through outer shell 5. The ends of collars 3 are inserted into fittings 1. O-rings 8 in notches in collar 3 prevent leakage of water from fitting 1 to the space between diaphragm 6 and pressure assembly 15. The fittings 1 are already attached to domes 2. For example, the assembly of fitting 1 and domes 2 may be assembled as a monolithic piece. Alternatively, fittings 1 may be welded to domes 2. When the collars 3 are inserted into fittings 1, the tank 10 is essentially assembled. The domes 2 are sealingly secured to outer shell 5, preferably by welding, to form pressure assembly 15. One skilled in the art will recognize that one dome 2 may be welded to shell 5 before inserting water chamber assembly 12. Welding techniques such as metal-inert gas (MIG) and tungsten-inert gas (TIG) may be used to join the domes 2 to outer shell 5. Those skilled in the art will recognize that a variety of welding techniques may be used to join the various parts of pressure assembly 15. Thus, an increase in pressure within the space between diaphragm 6 and pressure assembly 15 will not force the domes 2 off the ends of shell 5.

As noted above, at normal operating pressures, water simply flows from one end of the tank 10 to the other through tube 4. At normal operating pressures, the space between pressure assembly 15 and diaphragm 6 is pressurized so that the diaphragm is pushed against the outer wall of tube 4. In one embodiment, the pressure between pressure assembly 15 and diaphragm 6 is at least 5 psi. One skilled in the art will recognize that the appropriate pressure will depend on the capacity of the water heater, the diameter of the piping, and the total capacity of the system. If the water pressure within the tube 4 exceeds the pressure between diaphragm 6 and shell 5, then water will flow into the space between tube 4 and diaphragm 6 through slots 20 cut into the ends of tube 4. Preferably, each end of tube 4 includes two slots 20, offset by 180 degrees. One skilled in the art will realize that more slots may be included if desired. For example, four slots with an offset of 90 degrees may be included. When the water pressure within tube 4 decreases, the diaphragm 6 is forced back against the outside of tube 4, pushing the water back into the tube from the space between tube 4 and diaphragm 6 through the slots 20.

The tank 10 absorbs the increase in pressure from thermal expansion as water is heated in a hot water heater 30. A check valve 32 prevents the water from flowing back down supply side 34 from the heater 30. If there is no demand for the hot water (e.g., faucet 35 is closed), then the expanding water in the hot water heater 30 increases the pressure downstream of valve 32. While hot water heaters have pressure valves 36 to vent water and prevent damage to the heater, a homeowner is not likely to appreciate the safety advantages of having hot water venting out of the heater 30 into the basement. The in-line tank 10 of the invention is disposed between the check valve 32 and the hot water heater 30 on the supply side 34 (cold water side) of the heater 30. As water heats up, its expansion increases the upstream water pressure, and the diaphragm expands.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A in-line expansion tank, comprising:
a case having first and second passage fittings providing fluidic communication between an interior and an exterior of the case;
first and second collars sealingly connected to the first and second passage fittings, respectively;
a resilient diaphragm having first and second ends, wherein the first and second ends are sealingly connected to an exterior of the first and second collars, respectively; and
a tube retained between the first and second collars and having two ends, wherein one or both ends have a notch providing fluidic communication between an interior of the tube and an interior of the diaphragm.

2. The in-line expansion tank of claim 1, wherein the case is metallic and comprises a shell having first and second ends and first and second domes welded to the first and second ends of the shell, respectively, wherein the first and second passage fittings are disposed in a wall of the first and second domes, respectively.

3. The in-line expansion tank of claim 2, further comprising a valve providing controllable fluidic communication between an exterior of the tank and a space between the case and the diaphragm, wherein the valve is disposed in a wall of one of the domes or of the shell.

4. The in-line expansion tank of claim 1, wherein a cross-sectional area of the first and second ends of the diaphragm is smaller than a cross-sectional area of a middle portion of the diaphragm.

5. The in-line expansion tank of claim 1, wherein one or both of the ends of the tube have a plurality of notches.

6. The in-line expansion tank of claim 1, wherein at least a middle portion of the diaphragm is configured to contact the tube at normal operating pressures.

7. An in-line expansion tank, comprising:
a case having an inlet and an outlet;
a flow-through assembly having an interior and an exterior and first and second ends sealingly connected to the inlet and outlet, respectively; and
a resilient diaphragm having a middle portion and first and second ends sealingly connected to the flow-through assembly, wherein
the cross-sectional area of the first and second ends of the diaphragm are smaller than a cross-sectional area of the middle portion, and
a space between the exterior of the flow-through assembly and the interior of the diaphragm is in fluidic communication with the interior of the flow-through assembly.

8. The in-line expansion tank of claim 7, wherein the case is metallic and comprises a shell having two ends and first and second domes welded to the shell, wherein the inlet and the outlet each comprise a passage fitting disposed in a wall of one of the domes.

9. The in-line expansion tank of claim 8, further comprising a valve disposed in a wall of the case or of one of the domes.

10. The in-line expansion tank of claim 7, wherein at least a middle portion of the diaphragm is configured to contact the tube at normal operating pressures.

11. The in-line expansion tank of claim 7, wherein the flow-through assembly comprises:
first and second collars sealingly connected to the inlet and outlet, respectively; and
a tube retained between the first and second collars and having two ends, wherein one or both ends has a notch providing fluidic communication between an interior of the tube and an interior of the diaphragm.

12. The in-line expansion tank of claim 11, wherein one or both of the ends of the tube have a plurality of notches.

13. An in-line expansion tank, comprising:
a metallic case, comprising:
a shell having first and second ends;
first and second domes welded to the first and second ends of the shell, respectively; and
first and second fittings attached to the first and second domes, respectively, and adapted and constructed for connection to a plumbing system and providing fluidic communication between an interior and an exterior of the case;
a flow-through assembly having an interior and an exterior and first and second ends sealingly connected to the first and second fittings, respectively; and
a resilient diaphragm having inlet and outlet ends sealingly connected to the flow-through assembly, wherein a space between the exterior of the flow-through assembly and the interior of the diaphragm are in fluidic communication.

14. The in-line expansion tank of claim 13, further comprising a valve providing controllable fluidic communication between an exterior of the tank and a space between the metallic case and the diaphragm, wherein the valve is disposed in a wall of the shell or of one of the domes.

15. The in-line expansion tank of claim 13, wherein the flow-through assembly comprises:
first and second collars sealingly connected to the first and second domes, respectively; and
a tube retained between the first and second collars and having two ends, wherein one or both ends has a notch providing fluidic communication between an interior of the tube and an interior of the diaphragm.

16. The in-line expansion tank of claim 15, wherein one or both of the ends of the tube have a plurality of notches.

17. The in-line expansion tank of claim 13, wherein a cross-sectional area of the first and second ends of the diaphragm is smaller than a cross-sectional area of a middle portion of the diaphragm.

18. The in-line expansion tank of claim 13, wherein at least a middle portion of the diaphragm is configured to contact the tube at normal operating pressures.

19. A preassembled water chamber assembly for an expansion tank, comprising:
a tube having first and second ends;
first and second collars disposed at the first and second ends of the tube, respectively; and
a resilient diaphragm having first and second ends, the diaphragm disposed about the tube and the first and second ends of the diaphragm sealingly fitted around the first and second collars, respectively.

20. The water chamber assembly of claim 19, wherein a cross-sectional area of the first and second ends of the diaphragm is smaller than a cross-sectional area of a middle portion of the diaphragm.

21. The water chamber assembly of claim 19, wherein one or both ends of the tube has at least one notch.

22. The water chamber assembly of claim 21, wherein one or both of the ends of the tube have a plurality of notches.
